(19) United States
(12) Patent Application Publication
(10) Pub. No.: US 2004/0046303 A1
(43) Pub. Date: Mar. 11, 2004

(54) Method of manufacturing a book block from printed sheets connected at the folds by thread stitching and apparatus for carrying out the method

(76) Inventor: Marcel Stolz, Felben (CH)

Correspondence Address: Friedrich Kueffner, Suite 910, 317 Madison Avenue, New York, NY, 10017, US

(21) Appl. No.: 10/677,846

(22) Filed: Oct. 2, 2003

Related U.S. Application Data
(63) Continuation of application No. 09/465,952, filed on Dec. 17, 1999, now abandoned.

(30) Foreign Application Priority Data
Dec. 24, 1998 (EP) 98811262.9-2309

(51) Int. Cl. B41F 13/54

(52) U.S. Cl. 270/1.01

(57) ABSTRACT

A method and an apparatus for manufacturing a book block for books, brochures, or the like, from printed sheets connected to each other at the folds thereof by thread stitching, wherein the printed sheets are transferred in a sequence astride with the side portions thereof directed downwardly by means of a conveyor in an accelerated manner onto a feeding device which interacts with a stitching device arranged at a right angle relative to the folds of the printed sheets, such that the printed sheets arrive on the feeding device in the stitching position, and wherein the printed sheets are shifted to the stitching device for sewing the printed sheets to another printed sheet to form a book block. The feeding device is moved prior to the arrival of a printed sheet into the stitching position towards the stitching device.

### BACKGROUND OF THE INVENTION

1. Field of the Invention

The present invention relates to a method of manufacturing a book block for books, brochures, or the like, from printed sheets connected to each other at the folds thereof by thread stitching, wherein the printed sheets are transferred in a sequence astride with the side portions thereof directed downwardly by means of a conveyor in an accelerated manner onto a feeding device which interacts with a stitching device arranged at a right angle relative to the folds of the printed sheets, such that the printed sheets arrive on the feeding device in the stitching position, and wherein the printed sheets are shifted to the stitching device for sewing the printed sheets to another printed sheet to form a book block.

2. Description of the Related Art

As is well known, methods of this type are carried out on thread stitching machines. In these methods, the printed sheets which follow each other in a certain sequence are conveyed in the direction of their folds astride with downwardly directed side portions from a conveyor to a feeding device. The transfer to the feeding device is effected by two adjacent sections of endless traction means, for example, flat belts, which form a conveying path for accelerating and decelerating a printed sheet, wherein the traction means grasp the printed sheets at a side portion, and the transfer ends at an end of the conveying path formed by a stop.

For carrying out this step, the feeding device constructed for receiving the printed sheets in an astride position is located in an initial position which is in alignment with the conveyor.

Arranged at a right angle to the feeding device or to the fold of a printed sheet placed on the feeding device is a stitching device to which the printed sheets are supplied.

For feeding the printed sheets to the stitching device, the feeding device has a stitching saddle which can be pivoted into the stitching position of the stitching device, wherein the printed sheets are placed on the stitching saddle aligned in accordance with the stitching or sewing position in the stitching device. In the stitching position, the side portions of the printed sheets are still spread apart from each other so that the fold can be pricked by upwardly moving needles at the inner edge for preparing for the sewing procedure.

During this time and during the subsequent sewing of the printed sheets, the stitching saddle remains in the stitching position and the transfer of the next printed sheet can only take place when the stitching saddle assumes its initial position in which the next printed sheet can be supplied to the stitching saddle. The transfer of the printed sheets from the conveyor and the feeding of the stitching device take place synchronously timed.

During this processing cycle, unused time periods occur which have a disadvantageous effect on the efficiency or which prevent the possibility of a higher reliability.

### SUMMARY OF THE INVENTION

Therefore, it is the primary object of the present invention to utilize the processing cycle of a thread stitching machine during the transfer of the printed sheets to the feeding device and the sewing of the printed sheets in the stitching device for improving the reliability and quality and to make this process more efficient.

In accordance with the present invention, this object is met by moving the feeding device prior to the arrival of a printed sheet into the stitching position towards the stitching device.

The time saved as a result of the invention during this process can be utilized for reducing the speed or for improving the reliability while maintaining the production output, or for increasing the output.

For example, a stationary or movable stop could form the stitching position of the printed sheet on the feeding device or a stitching saddle.

In accordance with a preferred feature, a printed sheet supplied to the feeding device is moved towards the stitching device by the feeding device after the printed sheet has passed the rearward end of the feeding device as seen in the conveying direction.

Suitable for carrying out the method described above is an apparatus which includes a stitching device for sewing printed sheets at the folds thereof and to each other, and a feeding device which interacts with the stitching device and which moves the printed sheet received from the conveyor in an accelerated manner and aligned in accordance with the stitching position into a stitching location offset at a right angle, wherein the feeding device includes an accelerating device which grasps the printed sheets at the conveyor end of the conveyor and aligns the printed sheets in accordance with the stitching positions. In accordance with the present invention, the feeding device which can be moved in the direction towards the stitching device has a front conveying section as seen in the conveying directions of the printed sheets which can be moved into the stitching location of the stitching device. The front conveying section is constructed as a liftable stitching saddle.

As a result of the configuration according to the present invention, more time is available for carrying out the processing cycle without reducing the production output, wherein this time can be used for increasing the reliability and for improving the quality, or the time can be used for increasing the production output of the production cycle by a higher number of cycles per unit of time.

In accordance with a particularly advantageous feature, the feeding device has an inlet section arranged in front of the stitching saddle as seen in the conveying direction of a printed sheet.

In accordance with an advantageous feature, the stitching saddle is mounted on the feeding device so as to be pivotable by means of a drive about an axis extending parallel to the fold of a printed sheet, so that an oscillating pivoting movement can be realized in a simple manner.

Of course, the feeding device can be constructed so as to be guided along a straight line.

Preferably, the feeding device forming the stitching saddle is also mounted so as to be pivotable by means of a drive parallel relative to the pivoting axis of the stitching saddle, so that a simple and space-saving drive unit can be created.

A pivoting drive provided for the stitching saddle and the feeding device is advantageously connected to a control device which makes it possible to carry out the respective processing cycle in accordance with the processing cycle of a thread stitching machine.

For carrying out an adjustment to the processing cycle, particularly in the case of a change of the size and/or properties of the printed sheets, the control device can be constructed so as to be adjustable for changing the pivoting movement of the stitching saddle and the feeding device.

Moreover, it is advantageous if the stitching saddle is controlled so as to be liftable from the feeding device along its travel into the stitching location of the stitching device. In other words, the feeding device is controlled so as to trail relative to the stitching saddle on its way to the stitching device. The control can be carried out advantageously so as to be adjustable in accordance with the sizes of the printed sheets.

This makes it possible that the feeding device assumes in the stitching location of the stitching saddle a holding position which is backwardly offset relative to the stitching saddle in the feeding direction.

A feeding device composed of two parts makes it possible that the feeding device can be controlled so as to be returnable prior to the stitching saddle into the initial position, so that a next printed sheet can be received at an early time.

In order to make it possible that a printed sheet can maintain its unchanged position during the transport of the printed sheet from the initial position of the feeding device into the stitching location, a holding-down device is attached to the feeding device, wherein the holding-down device acts on the printed sheet which rests on the fold support of the stitching saddle.

The various features of novelty which characterize the invention are pointed out with particularity in the claims annexed to and forming a part of the disclosure. For a better understanding of the invention, its operating advantages, specific objects attained by its use, reference should be had to the descriptive matter in which there are described preferred embodiments of the invention.

### BRIEF DESCRIPTION OF THE DRAWING

In the drawing:

FIGS. 1a to 1h are schematic perspective views showing a processing cycle for thread stitching of printed sheets into book blocks in successive steps from conveying the printed sheets to the feeding device and moving the stitching saddle into the stitching location and back into the initial position; and

FIGS. 2a to 2f are schematic sectional views, on a larger scale, showing the steps of FIGS. 1a to 1h.

### DESCRIPTION OF THE PREFERRED EMBODIMENTS

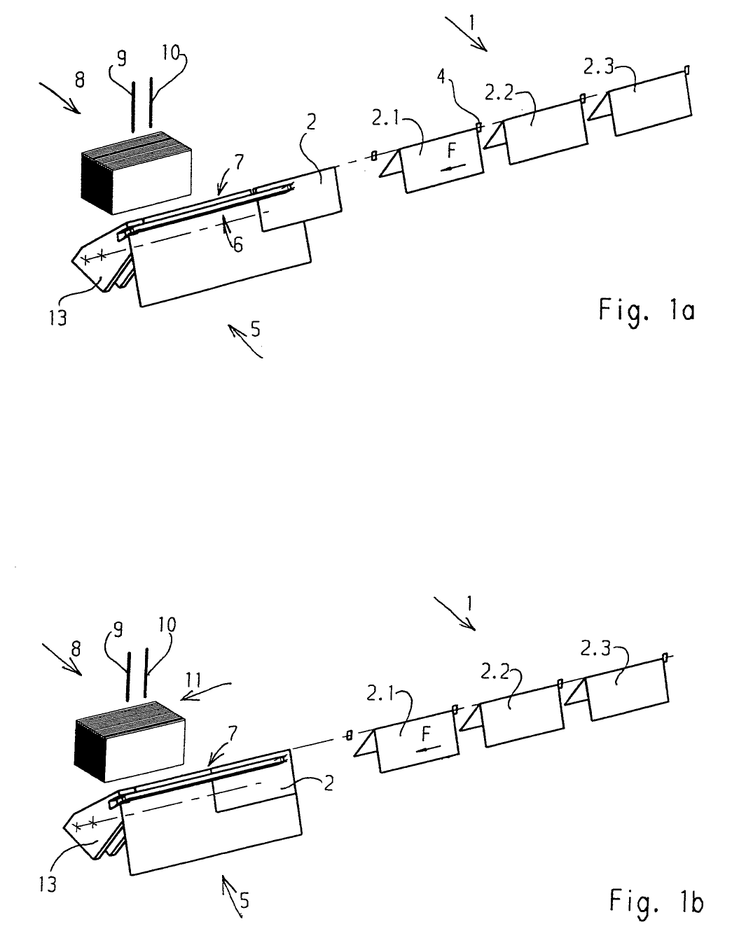

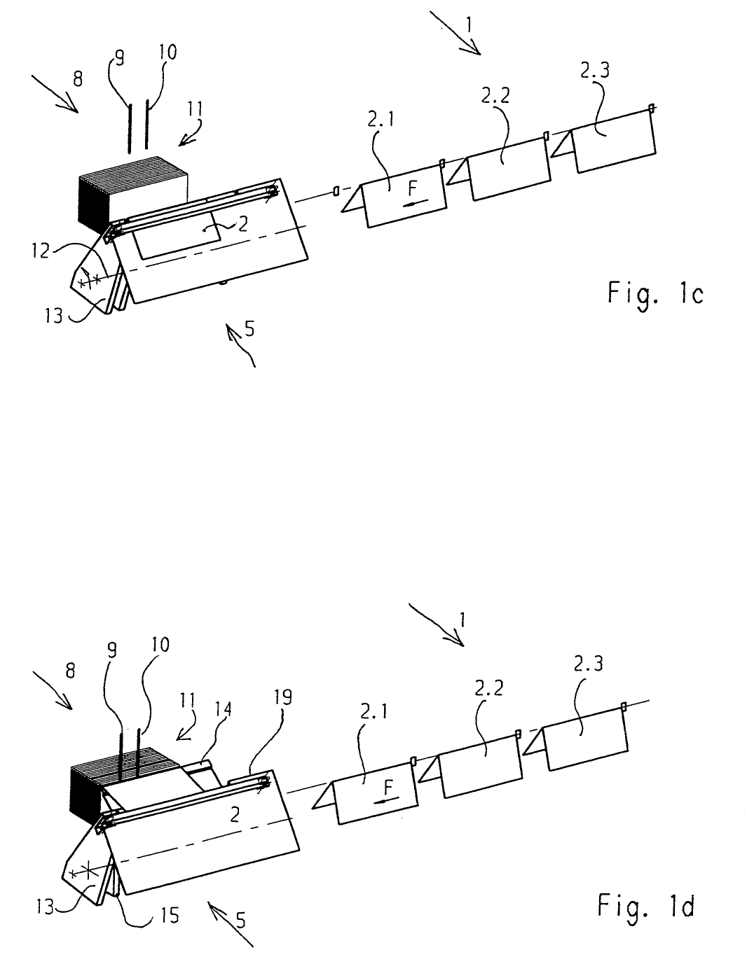

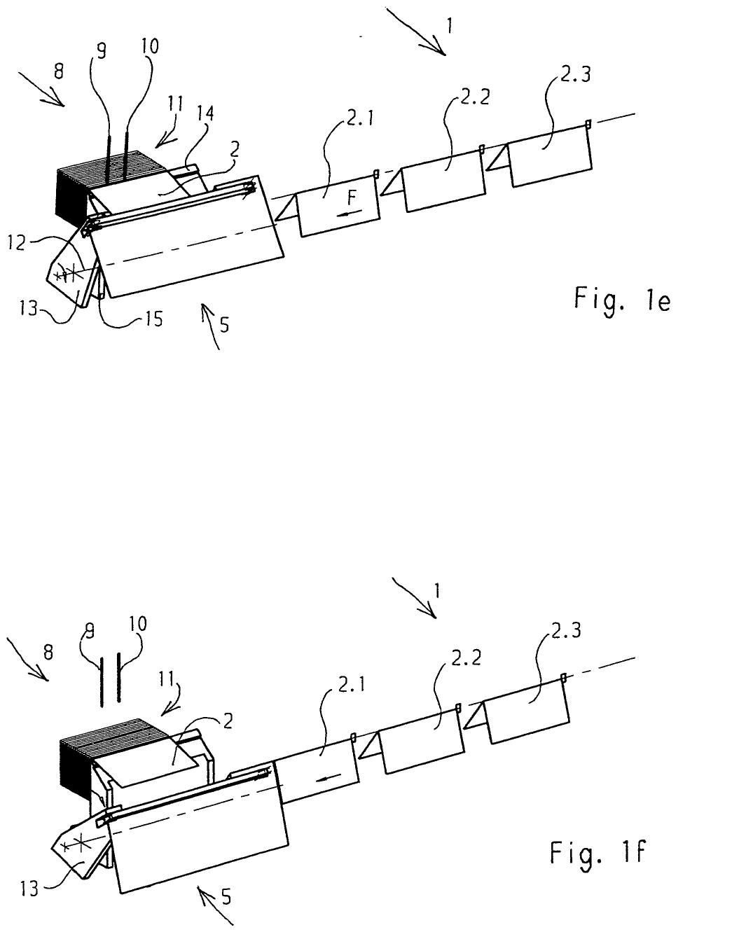

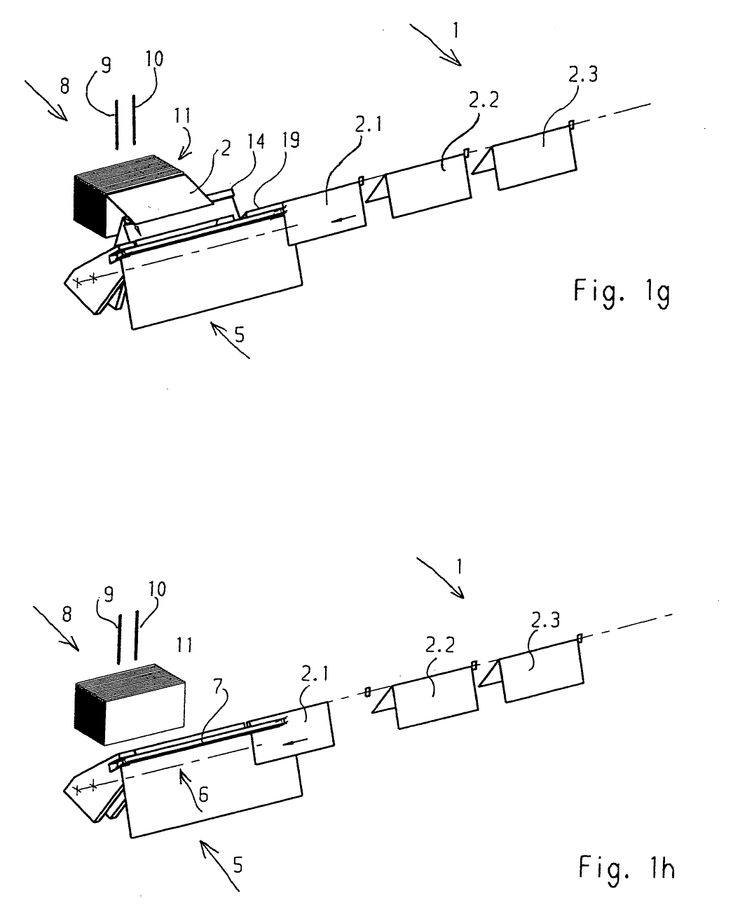

Before printed sheets 2 intended for a book block are transferred in a predetermined sequence to the conveyor 1 illustrated in FIGS. 1a to 1i, the printed sheets 2 are loosely combined in a gathering machine into book blocks and are subsequently individually conveyed into a magazine of a printed sheet feeder, not shown, arranged in front of the conveyor 1. This procedure is known in the art and is not part of the method according to the present invention or the apparatus for carrying out the method. This known procedure and the principles of thread stitching can be found in the applicable literature, for example, printed documents or “Industrielle Buchbinderei” [industrial book binding] of Liebau/Heinze, Verlag Beruf+Schule.

The printed sheets 2 are placed astride on the conveyor 1 and are further conveyed in a timed manner in the conveying direction F by means of an endless traction unit 3, shown in dash-dot lines, to which drive means 4 are connected.

A feeding device 5, also known as an inserting device, which is arranged without a step following the conveyor 1 in the conveying direction F and which is constructed saddle roof-shaped in cross-section, grasps and transports the printed sheet 2 arriving from the conveyor 1 by means of an accelerating device 6, formed by two adjacent endless conveyor belts 7, into a stitching position which corresponds to a stitching device 8 arranged laterally of the feeding device 5 in accordance with the stitching location of the printed sheet.

The stitching device 8 is schematically illustrated in the individual Figures as two sewing needles 9, 10. Usually a piercing needle and a hook needle form a pair of sewing needles. The sewing procedure is described, for example, in EP-B-0 537 106 and 0 603 126.

Before the printed sheet 2 has reached the final stitching location on the feeding device 5 and is still, for example, in the position according to FIG. 1b, the feeding device 5 begins to move into the stitching location at the front side of the printed sheet which is to be sewn to the book blocks 11.

As shown in FIG. 1c, the printed sheet 2 has at least approximately reached the stitching position on the feeding device 5; the position of the feeding device 5 has changed because it has been moved towards the stitching device 8. The movement towards the stitching device 8 is the result of a pivoting movement of the feeding device 5 about the axis 12 which changed position of the frame 13 of the feeding device relative to FIG. 1b.

In or in front of the approximate end location of the feeding device 5 shown in FIG. 1c, a conveying section, arranged in the front as seen in the conveying direction of the printed sheets 2 and constructed so as to be liftable out of the feeding device 5, is activated so as to move the printed sheets 2 into the stitching position according to FIG. 1d. The stitching saddle 14 is visible in FIG. 1d as a result of its changed position, wherein, in the illustrated embodiment, the pivot axis 12 of the feeding device 5 simultaneously forms the pivot axis of the stitching saddle 14 whose frame 15 indicates the changed position of the stitching saddle 14.

FIG. 1e shows the situation in which the printed sheet 2 which has just been placed on the stitching saddle 14 against the book block 11 is stitched to the book block 11; the sewing needles 9, 10 are in action and the feeding device 5 waits for the return movement of the stitching saddle 14 which is started by a control means, not shown. The additional printed sheets 2.1 to 2.3 have in the meantime moved closer to the feeding device 5.

The feeding device 5 which has been moved back after the return movement signal is now once again in the initial position in which it can receive the next printed sheet 2.1 arriving from the conveyor 1, as illustrated in FIG. 1f. An arrow at the pivot axis 12 indicated in FIG. 1e marks the return movement of the feeding device 5.

While the sewing procedure is being concluded and another printed sheet 2 has been attached to the book block 11, the printed sheet 2.1 has reached the feeding device 5 from the conveyor 1, as seen in FIG. 1f; the stitching saddle 14 is about to pivot back into the feeding device 5 in order to be able to timely receive printed sheet 2.1.

As illustrated in FIG. 1g, the stitching saddle 14 which forms part of the feeding device 5 has not yet reached its position of rest, however, the printed sheet 2.1 has now reached the saddle of the feeding device 5. As soon as the stitching saddle 14 has been moved back into the feeding device 5, the printed sheet 2.1 is grasped by the accelerating device 6 and is moved into the stitching location on the stitching saddle 14. This procedure results in a greater distance between the printed sheet 2.1 and the subsequent printed sheet 2.2 on the conveyor, as seen in FIG. 1h, wherein this increased distance is equal to a savings of time.

During the time between the return movement of the stitching saddle 14 and the forward movement thereof towards the stitching device 8, a so-called sheet stripping device 17 and a fold pressing device 18 ensure that the printed sheet 2 which has just been sewn on rests against the book block 11 so that the next sewing procedure can be carried out without problems and a clean stitch can be carried out.

A holding-down device 16 which is attached to the feeding device 5 and which presses the printed sheets 2 into the stitching location on the stitching saddle 14 advantageously influences the sewing procedure for obtaining an optimum connection of the printed sheets in the book block 11.

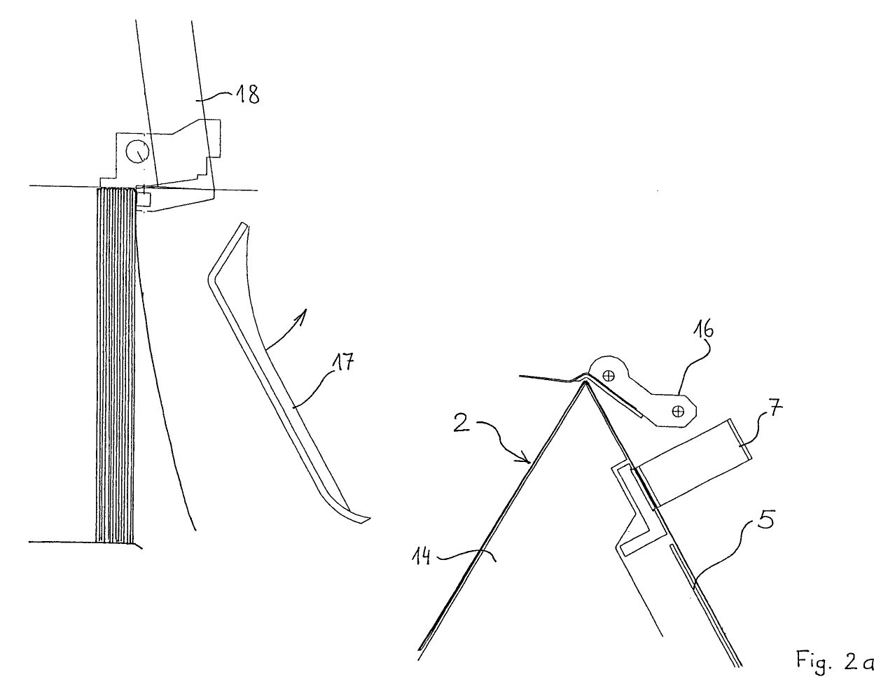

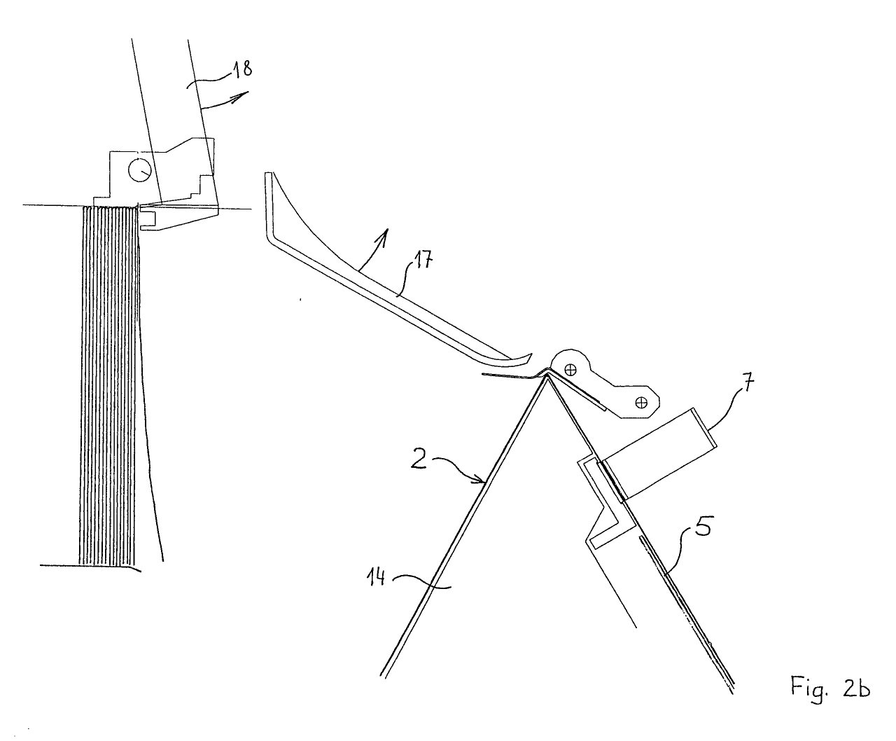

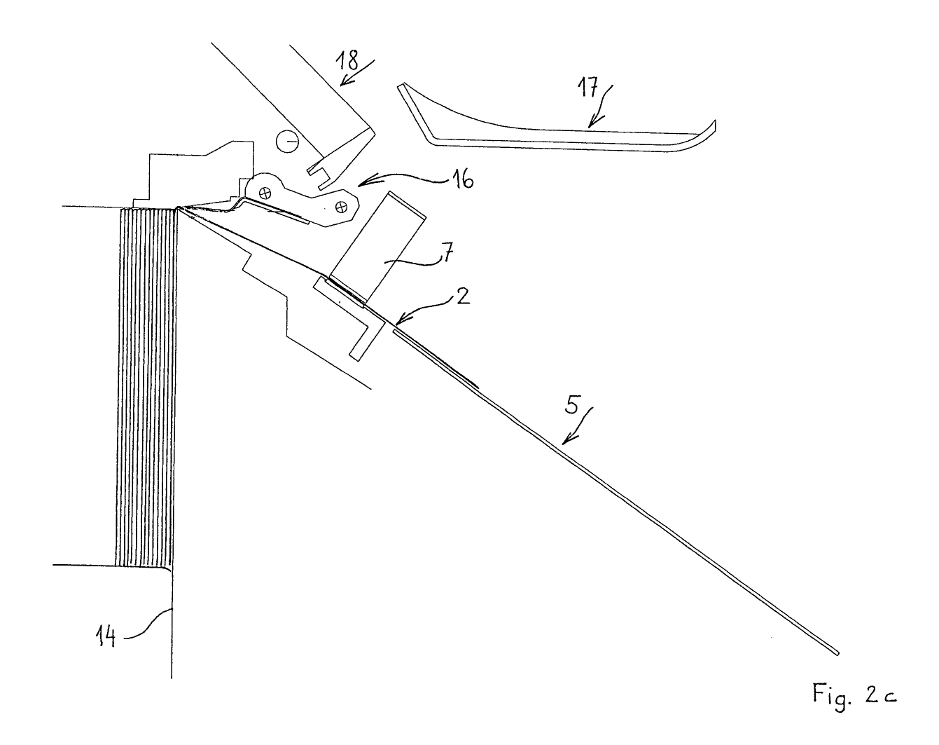

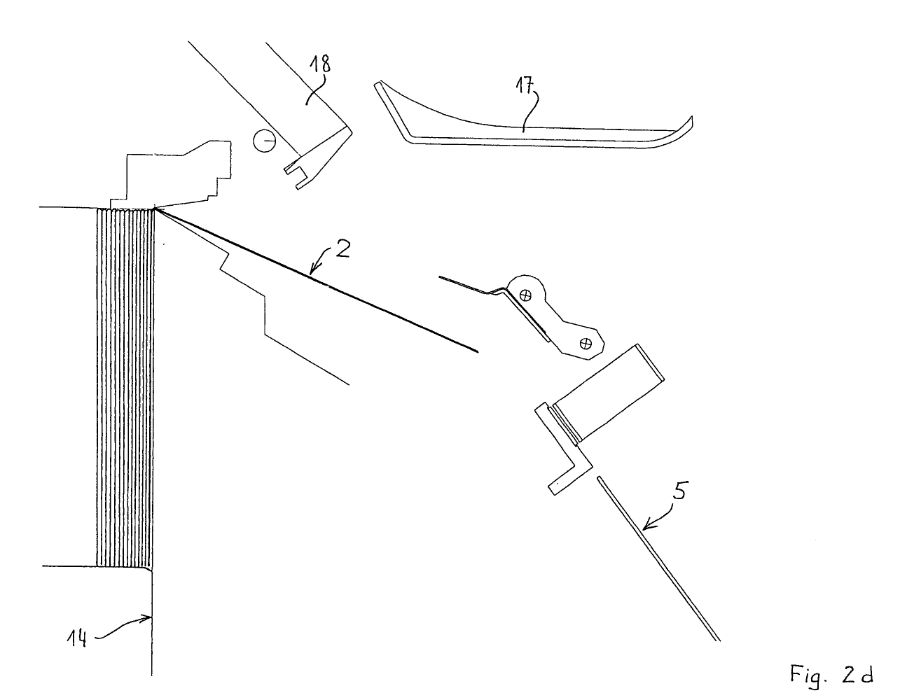

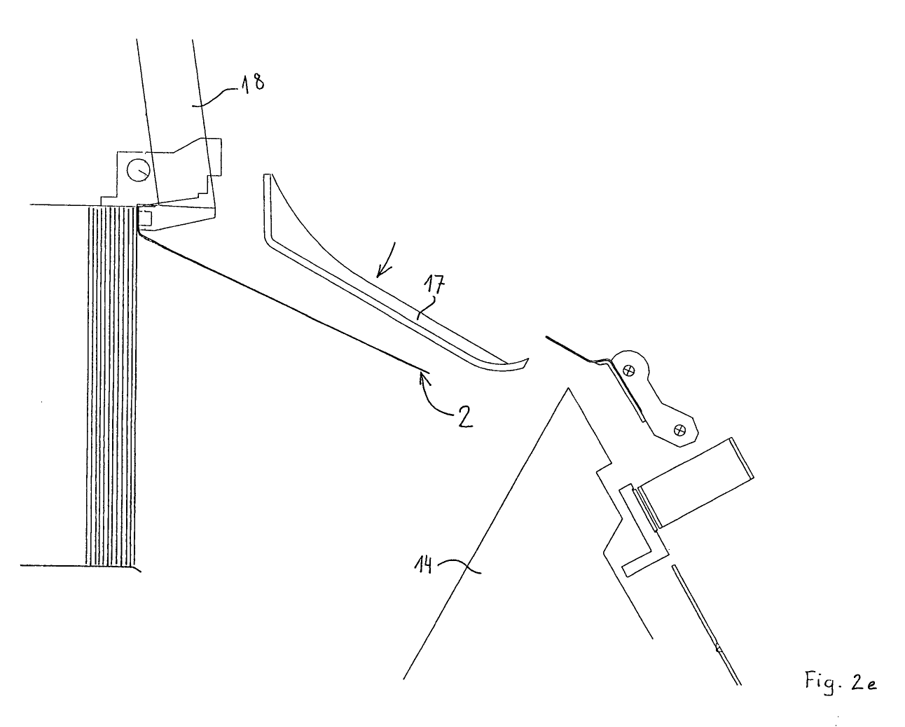

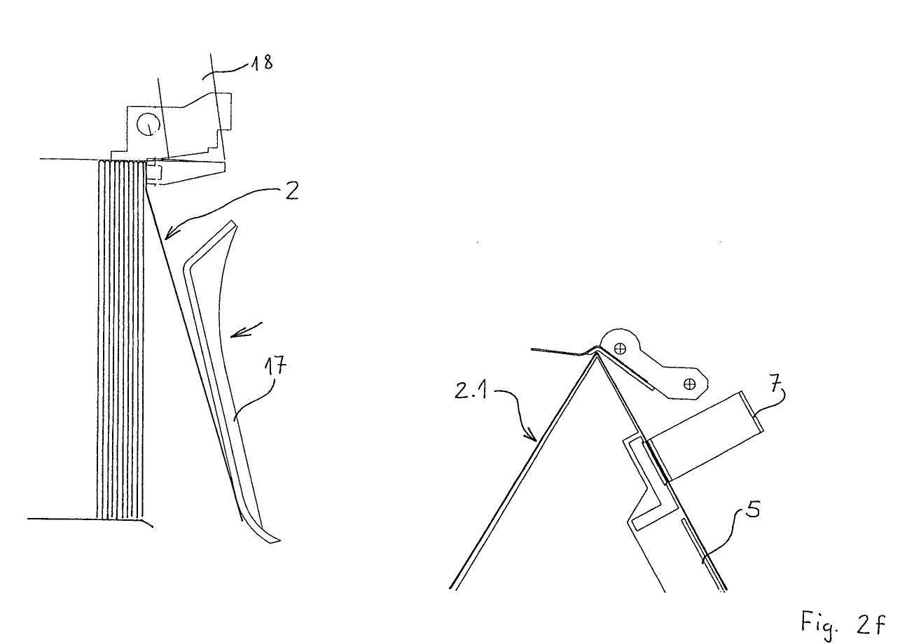

FIGS. 2a to 2f are schematic cross-sectional views showing the processing steps illustrated in FIGS. 1a to 1h. FIGS. 2a and 2b correspond to the positions according to FIGS. 1a and 1b, respectively, and approximately 1c; FIG. 2c approximately illustrates the situation according to FIGS. 1d and 1e; FIG. 2d shows the position shown in FIG. 1f; FIG. 2e corresponds to FIG. 1g and FIG. 2f shows the situation according to FIG. 1h.

While specific embodiments of the invention have been shown and described in detail to illustrate the inventive principles, it will be understood that the invention may be embodied otherwise without departing from such principles.

I claim:

1. A method of manufacturing a book block for books, brochures, or the like, from printed sheets connected to each other at folds thereof by thread stitching, the method comprising transferring the printed sheets in a sequence astride with side portions thereof directed downwardly by a conveyor in an accelerated manner onto a feeding device, wherein the feeding device is configured to interact with a stitching device arranged at a right angle relative to the folds of the printed sheets, such that the printed sheets arrive on the feeding device in a stitching position, and shifting the printed sheets to the stitching device for sewing the printed sheets to another printed sheet to form a book block, the method further comprising moving the feeding device into the stitching position towards the stitching device prior to the arrival of a printed sheet.

2. The method according to claim 1, comprising moving a printed sheet supplied to the feeding device towards the stitching device by the feeding device after the printed sheet has passed a rearward end of the feeding device in the conveying direction.

3. An apparatus for manufacturing a book block for books, brochures, or the like, from printed sheets connected to each other at folds thereof by thread stitching, the apparatus comprising a stitching device for sewing printed sheets at the folds thereof and to each other in a stitching position, and a feeding device configured to interact with and so as to be movable in a direction towards the stitching device for moving a printed sheet received from a conveyor in an accelerated manner and aligned in accordance with the stitching position into a stitching location offset at a right angle, the feeding device comprising an accelerating device for grasping the printed sheets at a conveyor end of the conveyor and for aligning the printed sheets in accordance with the stitching position, the feeding device comprising a front conveying section in a conveying direction of the printed sheets configured to be movable into the stitching location of the stitching device, wherein the front conveying section is comprised of a liftable stitching saddle.

4. The apparatus according to claim 3, wherein the feeding device comprises an inlet section arranged in front of the stitching saddle in the conveying direction.

5. The apparatus according to claim 3, wherein the stitching saddle is mounted on the feeding device so as to be pivotable by a drive about an axis extending parallel to the fold of the printed sheet.

6. The apparatus according to claim 3, wherein the feeding device is mounted so as to be pivotable by a drive parallel relative to the pivoting axis of the stitching saddle.

7. The apparatus according to claim 3, comprising a pivoting drive for the stitching saddle and the feeding device, and a control device connected to the pivoting drive.

8. The apparatus according to claim 7, wherein the control device is configured to be adjustable for changing the pivoting movements of the stitching saddle and of the feeding device.

9. The apparatus according to claim 3, wherein the stitching saddle is configured to be controlled so as to be lifted from the feeding device during the pivoting movement thereof into the stitching position of the stitching device.

10. The apparatus according to claim 9, wherein the feeding device has a holding position arranged backwardly offset relative to the stitching saddle in the feeding direction.

11. The apparatus according to claim 3, wherein the feeding device is configured to be controlled so as to be returnable into an initial position prior to the stitching saddle.

12. The apparatus according to claim 3, further comprising a holding-down device for acting on a fold support of the stitching saddle located in the stitching position.
